(19) United States
(12) Patent Application Publication
(10) Pub. No.: US 2022/0366411 A1
(43) Pub. Date: Nov. 17, 2022

(54) SYSTEMS AND METHODS FOR TIERED VIRTUAL CARD NUMBER PROCESSING

(71) Applicant: Capital One Services, LLC, McLean, VA (US)

(72) Inventors: Minahil Bajwa, Falls Church, VA (US); Esther Scott, Arlington, VA (US); Brandee Shin, Herndon, VA (US)

(21) Appl. No.: 17/320,789

(22) Filed: May 14, 2021

(51) Int. Cl. G06Q 20/40; G06Q 20/34

(52) U.S. Cl. CPC G06Q 20/401; G06Q 20/351

(57) ABSTRACT

A system may include one or more processors, a memory in communication with the one or more processors, and storing instructions, that when executed by the one or more processors, are configured to cause the system to generate VCNs. The system may generate a first parent VCN based on one or more first limits, and a plurality of child VCNs based on one or more second limits. The system may transmit the plurality of child VCNs to a plurality of first users and determine whether an attempted transaction utilizing one of the plurality of child VCNs falls within the first and second limits. When the attempted transaction falls within the first and second limits, the system may approve the attempted transaction. When the attempted transaction falls outside of the first limits or the second limits, the system may deny the attempted transaction.

### FIELD

The disclosed technology relates to systems and methods for tiered virtual card number processing, and more particularly to generation of tiered virtual card numbers for use in shared events.

### BACKGROUND

Primary account holders often find themselves in situations where they would like to provide financial backing for transactions made by other users, but do not necessarily want to supply those other users with the primary account holder's own account information. For example, a boss may want to supply lunch for a group of employees across multiple sites, or a parent may want to provide his or her children with a certain shopping allowance. In such situations, the primary account holder (e.g., the boss or parent) may not want to give the group of users his or her physical card (e.g., a credit card or debit card) or card number, but may still want to financially back the transactions made by the group of users, while placing limits on when, where, and how those transactions may be made.

Traditional systems and methods for enabling a primary account holder to financially back transactions of others typically require the primary account holder to add the other users as authorized users on the primary account holder's own account. However, a primary account holder may not want an entire group of users to be directly linked to the primary account holder's own account information. Further, traditional systems and methods do not enable a primary account holder to lend control to other users over their own accounts, while simultaneously maintaining access to information pertaining to those accounts. Traditional systems and methods may allow a primary account holder to supply other users with prepaid cards (e.g., gift cards). However, prepaid cards are often very limited in how they may be used (e.g., merchant-specific), and usually cannot be financially backed by a primary account holder in real-time (e.g., by being linked to the primary account holder's credit or debit card account).

Accordingly, there is a need for improved systems and methods that allow a primary account holder to financially back and manage transactions made by other users, without the need for directly linking the users to the primary account holder's own account. Embodiments of the present disclosure are directed to this and other considerations.

### SUMMARY

Disclosed embodiments provide systems and methods for tiered virtual card number (VCN) processing that enable a primary account holder to financially support and manage transactions of a group of users without the need for sharing the primary account holder's personal financial information with the users.

Consistent with the disclosed embodiments, a system may include one or more processors and a memory in communication with the one or more processors and storing instructions, that when executed by the one or more processors, are configured to cause the system to perform a method for processing tiered VCNs. For example, the system may receive a selection of a first account (e.g., a financial account) associated with a first card number (e.g., a credit card number) to generate a first parent VCN and a plurality of child VCNs. The system may receive one or more first limits for the first parent VCN (e.g., a total spending limit across the plurality of child VCNs) and one or more second limits for the plurality of child VCNs (e.g., a spend limit, use limit, time limit, location limit, etc.). The system may generate the first parent VCN based on the one or more first limits, wherein the first parent VCN is different from the first card number. The system may generate the plurality of child VCNs that are each different from the first parent VCN and each other and are subject to the one or more first limits of the first parent VCN, and wherein each of the plurality of child VCNs is associated with the one or more second limits. The system may transmit the plurality of child VCNs to a plurality of first users (e.g., via email). The system may receive a notification associated with an attempted transaction that a first user of the plurality of first users has attempted to use a first child VCN of the plurality of child VCNs for completing a transaction, wherein the notification comprises attempted transaction data (e.g., the date, time, merchant, dollar amount, etc. of the attempted transaction). The system may determine whether the attempted transaction data falls within the one or more first limits and the one or more second limits. Responsive to determining that the attempted transaction data falls within the one or more first limits and the one or more second limits (i.e., the transaction meets the required limits), the system may approve the attempted transaction. Responsive to determining that the attempted transaction data falls outside of the one or more first limits or the one or more second limits (i.e., the transaction fails to meet the required limits), the system may deny the attempted transaction. The disclosed embodiments provide the benefit of enabling a primary account holder to financially back and manage a plurality of accounts that are linked to the primary account holder's account, but that each have unique card numbers to help maintain confidentiality. Further, the primary account holder may generate a plurality of child accounts for the purpose of user participation in a shared event (e.g., a company lunch).

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a block diagram of an example system environment that may be used to implement one or more embodiments of the present disclosure;

FIG. 2 is a component diagram of a virtual number generating system in accordance with some embodiments;

FIG. 3 is a flowchart of a method for tiered virtual card number processing, in accordance with some embodiments;

FIG. 4 is a flowchart of a method for tiered virtual card number processing, in accordance with some embodiments; and

FIG. 5 is a flowchart of a method for tiered virtual card number processing, in accordance with some embodiments.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

By way of introduction, aspects discussed herein may relate to systems and methods for tiered VCN processing. For example, some embodiments describe generating a first parent VCN and a plurality of child VCNs that are managed by the first parent VCN, wherein both the first parent VCN and the plurality of child VCNs are subject to one or more limits. These provide advantages over other systems and methods by allowing a primary account holder to financially back and manage a plurality of other user accounts that are linked to the primary account holder's account, but that each have unique card numbers to help maintain confidentiality of the primary account holder's own financial account information. These systems and methods also enable a primary account holder to lend at least some degree of control to a plurality of users over a series of accounts, while still accessing information pertaining to those accounts. As such, the following discussion describes several exemplary systems and methods for generation and use of tiered VCNs.

Reference will now be made in detail to example embodiments of the disclosed technology that are illustrated in the accompanying drawings and disclosed herein. Wherever convenient, the same reference numbers will be used throughout the drawings to refer to the same or like parts.

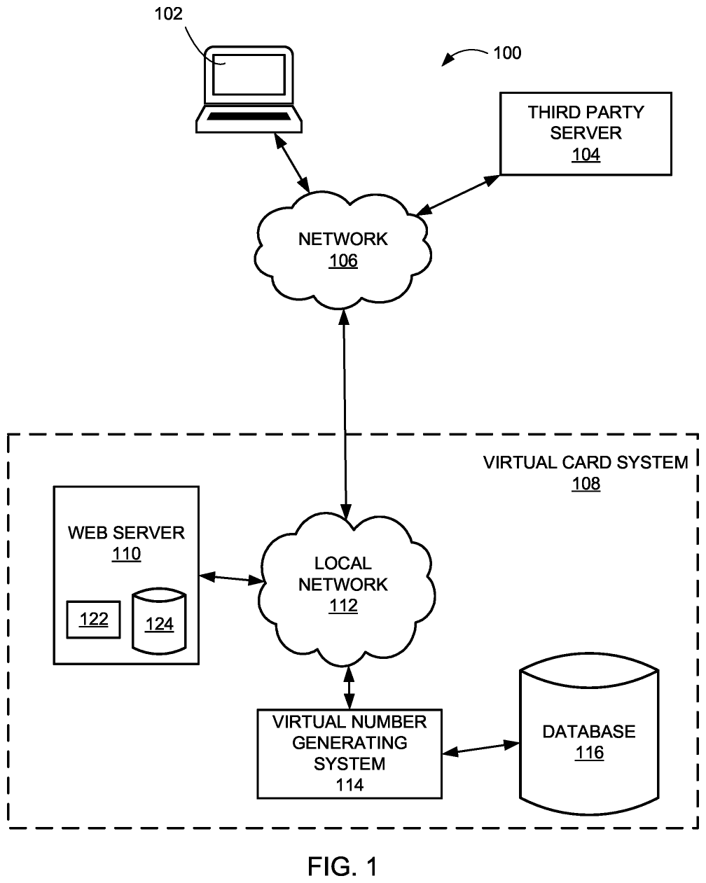

FIG. 1 is a diagram of an example system environment that may be used to implement one or more embodiments of the present disclosure. The components and arrangements shown in FIG. 1 are not intended to limit the disclosed embodiments as the components used to implement the disclosed processes and features may vary.

In accordance with disclosed embodiments, system 100 may include a user device 102 in communication with a virtual card system 108 via a network 106. System 100 may also include a third-party server 104. System 100 may be associated with and optionally controlled by one or more entities such as a business, corporation, individual, partnership, or any other entity that provides one or more of goods, services, and consultations to individuals such as customers. System 100 may include one or more servers and computer systems for performing one or more functions associated with products and/or services that the organization provides. For example, system 100 may include virtual card system 108 for VCN generation and processing.

User device 102 may be a mobile computing device (e.g., a smart phone, tablet computer, smart wearable device, portable laptop computer, voice command device, wearable augmented reality device, or other mobile computing device), a stationary device (e.g., desktop computer), or any other device capable of communicating with network 106 and ultimately communicating with one or more components of the system 100. In some embodiments, user device 102 may include or incorporate electronic communication devices for hearing or vision impaired users. User device 102 may be operated by a user, which may include individuals such as, for example, subscribers, clients, prospective clients, or customers of an entity associated with an organization, such as individuals who have obtained, will obtain, or may obtain a product, service, or consultation from an entity associated with system 100. According to some embodiments, user device 102 may include an environmental sensor for obtaining audio or visual data, such as a microphone and/or digital camera, a geographic location sensor for determining the location of the device, an input/output device such as a transceiver for sending and receiving data, a display for displaying digital images, one or more processors including a sentiment depiction processor, and a memory in communication with the one or more processors.

In accordance with certain embodiments, user device 102 may also be in communication with third-party server 104 via network 106. In certain embodiments, third-party server 104 may include a computer system associated with an entity (other than the entity associated with system 100 and its users) that performs one or more functions associated with the users.

Network 106 may be of any suitable type, including individual connections via the internet such as cellular or WiFi networks. In some embodiments, network 106 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Virtual card system 108 may include a web server 110, a local network 112, a virtual card generating system 114, and a database 116. Virtual card system 108 may include any other computer systems necessary to accomplish tasks associated with the organization or the needs of users (which may be customers of the entity associated with the organization).

Web server 110 may include a computer system configured to generate and provide one or more websites accessible to customers, as well as any other individuals involved in an organization's normal operations. For example, web server 110 may include a computer system configured to receive communications from user device 102 via, e.g., a mobile application, a chat program, an instant messaging program, a voice-to-text program, an SMS message, email, or any other type or format of written or electronic communication. Web server 110 may have one or more processors 122 and one or more web server databases 124, which may be any suitable repository of website data. Information stored in web server 110 may be accessed (e.g., retrieved, updated, and added to) via local network 112 (and/or network 106) by one or more devices, e.g., virtual number generating system 114, of system 100.

Local network 112 may include any type of computer networking arrangement used to exchange data in a localized area, such as WiFi, Bluetooth™ Ethernet, and other suitable network connections that enable components of system 100 to interact with one another and to connect to network 106 for interacting with components in the system 100 environment. In some embodiments, local network 112 may include an interface for communicating with or linking to network 106. In other embodiments, certain components of system 100 may communicate via network 106, without a separate local network 112.

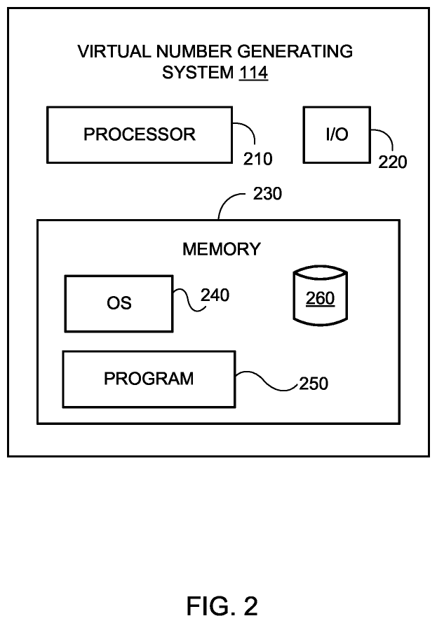

Virtual card system 108 may include one or more computer systems configured to compile data from a plurality of sources, such as web server 110, virtual number generating system 114, and/or database 116. Virtual number generating system 114 may correlate compiled data, analyze the compiled data, arrange the compiled data, generate derived data based on the compiled data, and store the compiled and derived data in a database such as database 116. According to some embodiments, database 116 may be a database associated with an organization and/or a related entity that stores a variety of information relating to customers, transactions, and business operations. Database 116 may also serve as a back-up storage device and may contain data and information that is also stored on, for example, databases 124 and 260, as discussed with reference to FIG. 2.

An example embodiment of virtual number generating system 114 is shown in more detail in FIG. 2. As shown, virtual number generating system 114 may include a processor 210, an input/output (“I/O”) device 220, a memory 230 containing an operating system (“OS”) 240, a program 250, and a database 260. For example, virtual number generating system 114 may be a single server or may be configured as a distributed computer system including multiple servers or computers that interoperate to perform one or more of the processes and functionalities associated with the disclosed embodiments. In some embodiments, virtual number generating system 114 may further include a peripheral interface, a transceiver, a mobile network interface in communication with processor 210, a bus configured to facilitate communication between the various components of virtual number generating system 114, and a power source configured to power one or more components of virtual number generating system 114.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™ low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor(s) 210 to communicate with other devices via wired or wireless networks, whether local or wide area, private or public, as known in the art. A power source may be configured to provide an appropriate alternating current (AC) or direct current (DC) to power components.

As described above, virtual number generating system 114 may be configured to remotely communicate with one or more other devices, such as user device 102.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files, including an operating system, application programs (including, e.g., a web browser application, a widget or gadget engine, or other applications, as necessary), executable instructions, and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Virtual number generating system 114 may include one or more storage devices configured to store information used by processor 210 (or other components) to perform certain functions related to the disclosed embodiments. In one example, virtual number generating system 114 may include memory 230 that includes instructions to enable processor 210 to execute one or more applications, such as server applications, network communication processes, and any other type of application or software known to be available on computer systems. Alternatively, the instructions, application programs, etc., may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, virtual number generating system 114 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, virtual number generating system 114 may include memory 230 that may include one or more programs 250 to perform one or more functions of the disclosed embodiments. Moreover, processor 210 may execute one or more programs 250 located remotely from virtual number generating system 114. For example, virtual number generating system 114 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include database 260 for storing related data to enable virtual number generating system 114 to perform one or more of the processes and functionalities associated with the disclosed embodiments.

Virtual number generating system 114 may also be communicatively connected to one or more memory devices (e.g., databases (not shown)) locally or through a network. The remote memory devices may be configured to store information and may be accessed and/or managed by virtual number generating system 114. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

Virtual number generating system 114 may also include one or more I/O devices 220 that may include one or more interfaces for receiving signals or input from devices and providing signals or output to one or more devices that allow data to be received and/or transmitted by virtual number generating system 114. For example, virtual number generating system 114 may include interface components, which may provide interfaces to one or more input devices, such as one or more keyboards, mouse devices, touch screens, track pads, trackballs, scroll wheels, digital cameras, microphones, sensors, and the like, that enable virtual number generating system 114 to receive data from one or more users (such as via user device 102).

In example embodiments of the disclosed technology, virtual number generating system 114 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While virtual number generating system 114 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations may include a greater or lesser number of components than those illustrated.

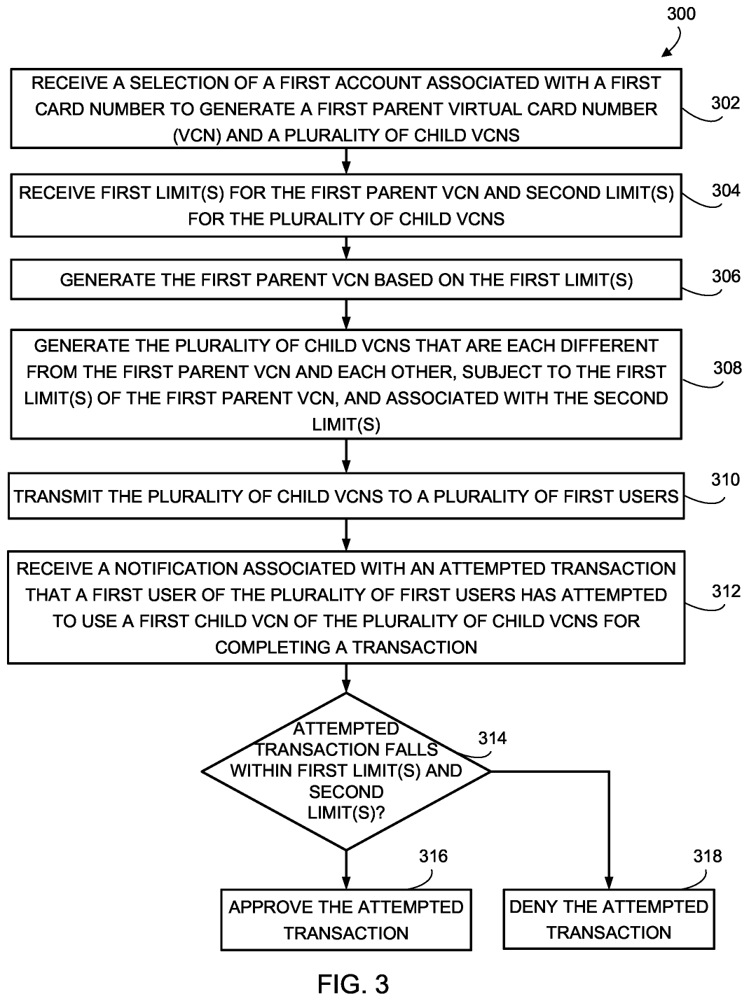

FIG. 3 shows a flowchart of a method 300 for performing tiered VCN processing. Method 300 may be performed by virtual number generating system 114, user device 102, and/or third-party server 104.

In block 302, the system (e.g., system 100) may receive a selection of a first account associated with a first card number to generate a first parent VCN and a plurality of child VCNs. For example, the first account may be a financial account or bank account, and the first card number may be a credit card or debit card number. The first account may be selected by an account holder via, e.g., a graphical user interface (GUI) of user device 102. The first account may provide financial backing for the generated first parent VCN and the plurality of child VCNs, as further described below.

In block 304, the system (e.g., system 100) may receive one or more first limits for the first parent VCN and one or more second limits for the plurality of child VCNs. The one or more first limits may comprise, for example, a total number of child VCNs permitted to be generated and/or a total spending limit across the plurality of child VCNs. That is, the first parent VCN may allow for a total spending limit of, e.g., $100 across a plurality of ten total child VCNs. The one or more second limits may comprise, for example, a spend limit, a use limit, a time limit, a location limit, or a combination thereof. That is, each of the plurality of child VCNs may be limited to a spend limit (e.g., a dollar amount), a use limit (e.g., single-use, multi-use, recurring use, etc.), a time limit (e.g., based on a predefined date or time expiration), a purchase type limit (e.g., a category of goods or services, or a merchant category code (MCC)), and/or a location limit (e.g., geographic-specific, merchant-specific, etc.). System 100 may receive the one or more first limits and the one or more second limits from an account holder via, e.g., a GUI of user device 102.

In block 306, the system (e.g., system 100) may generate (via, e.g., virtual number generating system 114) the first parent VCN based on the one or more first limits. The first parent VCN may correspond with or be linked to the selected first account so that the account holder may make online or in-person payments. Such in-person payments may be made by, e.g., manually typing a first parent VCN into a keypad of a merchant point-of-sale (POS) device, scanning a pre-generated QR code or other image, etc. The first parent VCN may be a temporary number such as a one-time use number that can only be used for a single transaction. The first parent VCN may have the capability to generate a plurality of child VCNs that may each correspond with or be linked to the first parent VCN such that the first parent VCN may manage the plurality of child VCNs. The first parent VCN may be pseudo-random. That is, the number may be generated so that some digits correspond with a particular card network (e.g., Visa, Mastercard) or with the issuer of a card. For example, the first digit in a credit card number denotes the card network (e.g., 4 is Visa, 5 is Mastercard). After that, the next five digits identify the card issuer (e.g., 14709 is Capital One). The next ten or so digits identify the individual account of a user. In a sixteen-digit credit card number, for example, some digits may be randomly generated while other digits may be assigned based on the affiliated card network and the card issuer. In other embodiments, the virtual number may be completely random.

Once generated, the first parent VCN may be, for example, transmitted to user device 102. The first parent VCN may be different from the card number of the selected first account. In addition, the first parent VCN may have a unique expiration date and card verification value (CVV) that are generated by the virtual number generating system 114 with the first parent VCN. The expiration date may be any date in the future. For example, the expiration date may be set to be three years ahead of the current date. The CVV may be randomly generated. Additionally, the first parent VCN may be generated as a token.

In block 308, the system (e.g., system 100) may generate the plurality of child VCNs that are each different from the first parent VCN and each other and are subject to the one or more first limits of the first parent VCN, and wherein each of the plurality of child VCNs is associated with the one or more second limits. Once again, each of the plurality of child VCNs may have an account number that is unique from that of the first parent VCN and that of the selected first account so as to preserve confidentiality and separation between the different account numbers and account users. Additionally, as described above with respect to the first parent VCN, each of the plurality of child VCNs may be generated as a token.

In block 310, the system (e.g., system 100) may transmit the plurality of child VCNs to a plurality of first users. For example, an account holder may enter (e.g., via a GUI of user device 102) a respective email address for each of the plurality of first users such that the system may link a respective child VCN to each of the plurality of first users. The plurality of child VCNs may also be transmitted to the plurality of first users via other means, e.g., SMS messaging, a push notification, a shared application, etc. (for digital use), or a printed QR code, bar code, gift card, etc. (for in-person use).

In block 312, the system (e.g., system 100) may receive a notification associated with an attempted transaction that a first user of the plurality of first users has attempted to use a first child VCN of the plurality of child VCNs for completing a transaction (e.g., via third-party server 104), wherein the notification comprises attempted transaction data. That is, when a user of one of the plurality of child VCNs attempts to use that child VCN for completing either an online or in-person transaction (e.g., purchasing a meal), an account holder of the first parent VCN may receive a notification (e.g., via a GUI of user device 102) alerting the account holder of the attempted transaction. The attempted transaction data included in the notification may be, e.g., transaction amount, merchant name, geographic location, date, time, number of times this specific child VCN has been used, etc.

In block 314, the system (e.g., system 100) may determine whether the attempted transaction data falls within the one or more first limits and the one or more second limits. For example, if one of the one or more first limits is a total spending limit across the plurality of child VCNs, the system may determine whether the attempted transaction resulted in the total spending limit being achieved, or being exceeded, or if there is additional funding within the total spending limit that is still available for use. With respect to the one or more second limits, if one of the one or more second limits is, e.g., a spend limit on the particular child VCN utilized in the attempted transaction, the system may determine whether the dollar amount of the attempted transaction is greater than, less than, or equal to the spend limit. As another example, if one of the one or more second limits is, e.g., a time limit, the system may determine whether the attempted transaction was made on an appropriate day and/or at an appropriate time to match the imposed time limit.

In block 316, the system (e.g., system 100) may, responsive to determining that the attempted transaction data falls within the one or more first limits and the one or more second limits, approve the attempted transaction. For example, one of the one or more first limits, as described above, may be a total spending limit across the plurality of child VCNs. One of the one or more second limits, as described above, may be a spend limit on the particular child VCN utilized in the attempted transaction. In this case, if the attempted transaction data indicates the attempted transaction did not result in the total spending limit across the plurality of child VCNs being exceeded, and also indicates the attempted transaction was at least less than or equal to the spend limit, the system may approve the attempted transaction. Approving of the attempted transaction may be a manual process (e.g., an account holder may respond to a prompt via a GUI of user device 102) or may be an automatic function (e.g., set up at the time the first parent VCN and/or the plurality of child VCNs are generated). The system may then transmit transaction information (date, time, transaction amount, merchant name, etc.) and an additional notification indicating the attempted transaction was approved to user device 102. That is, an account holder of the first parent VCN may receive a notification (e.g., via a GUI of user device 102) alerting the account holder that the attempted transaction was approved by displaying at least some of the transaction information and an approval indication. The system may cause user device 102 to dynamically update with the received transaction information for each attempted transaction of the plurality of child VCNs. That is, an account holder may receive (via user device 102) transaction information and a notification each time an attempted transaction of the plurality of child VCNs is approved. In response, the system may cause user device 102 to dynamically update a GUI (e.g., of user device 102) to display one or more notifications in a certain order, such as by date, time, transaction amount, etc., of each approved transaction, or transaction information associated with each approved transaction in a certain order, such as by date, time, transaction amount, etc. The ordering of how notifications and/or transaction information are displayed may be based on an account holder's previously entered display preferences (e.g., most recent transaction displayed first, or transactions listed by transaction amount from high to low).

In block 318, the system (e.g., system 100) may, responsive to determining that the attempted transaction data falls outside of the one or more first limits or the one or more second limits, deny the attempted transaction. For example, as described above with respect to block 316, if the attempted transaction data indicates the attempted transaction resulted in the total spending limit across the plurality of child VCNs being exceeded, the system may deny the attempted transaction. Similarly, if the attempted data indicates the attempted transaction was greater than the spend limit of the particular child VCN, the system may deny the attempted transaction. In some embodiments, in addition to denying the attempted transaction, the system may cancel the plurality of child VCNs so they may no longer be utilized. The system may also cancel the first parent VCN to end or close all open child VCNs of the plurality of child VCNs. The system may also cancel only the particular child VCN that exceeded its respective spend limit. In this case, the system may cancel the particular child VCN without impacting the remaining child VCNs of the plurality of child VCNs. Denying the attempted transaction and/or canceling of one or more child VCNs of the plurality of VCNs may be a manual process (e.g., an account holder may respond to a prompt via a GUI of user device 102) or may be an automatic function (e.g., set up at the time the first parent VCN and/or the plurality of child VCNs are generated). The system may then transmit the attempted transaction data (date, time, transaction amount, merchant name, etc.) and an additional notification indicating the attempted transaction was denied to user device 102. That is, an account holder of the first parent VCN may receive a notification (e.g., via a GUI of user device 102) alerting the account holder that the attempted transaction was denied by displaying at least some of the attempted transaction data and a denial indication. The system may cause user device 102 to dynamically update with the attempted transaction data for each attempted transaction of the plurality of child VCNs. That is, an account holder may receive (via user device 102) attempted transaction data and a notification each time an attempted transaction of the plurality of child VCNs is denied. In response, the system may cause user device 102 to dynamically update a GUI (e.g., of user device 102) to display one or more notifications in a certain order, such as by date, time, transaction amount, etc., of each denied transaction, or attempted transaction data associated with each denied transaction in a certain order, such as by date, time, transaction amount, etc. The ordering of how notifications and/or attempted transaction data are displayed may be based on an account holder's previously entered display preferences (e.g., most recent transaction displayed first, or transactions listed by transaction amount from high to low).

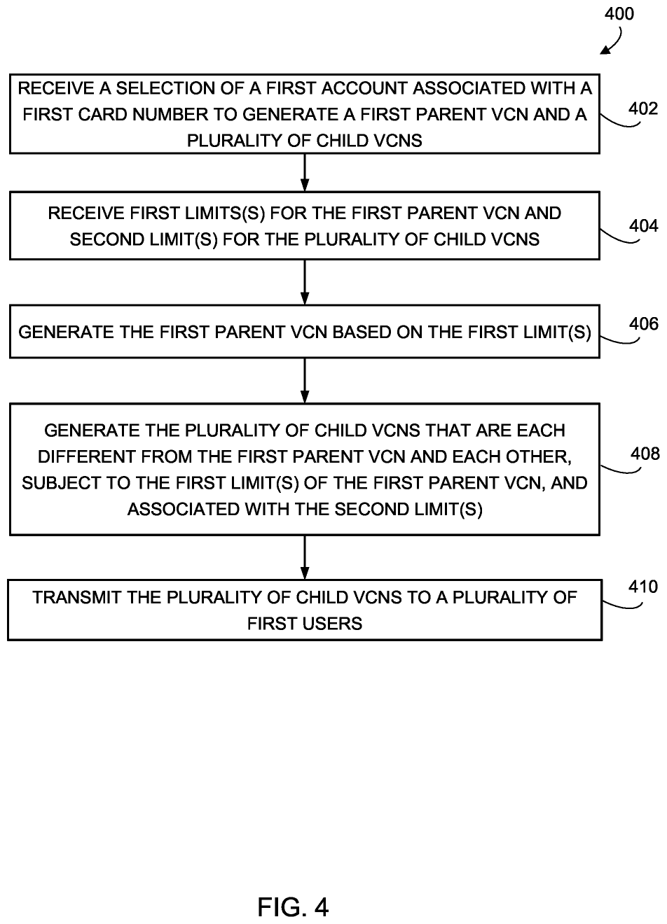

FIG. 4 shows a flowchart of a method 400 for generating tiered VCNs. Method 400 may also be performed by virtual number generating system 114, user device 102, and/or third-party server 104. Method 400 is similar to method 300 of FIG. 3 except that method 400 does not include blocks similar to blocks 312, 314, 316, and 318. The descriptions of blocks 402, 404, 406, 408, and 410 of method 400 are the same as or similar to the respective descriptions of blocks 302, 304, 306, 308, and 310 of method 300, and as such, are not repeated herein for brevity.

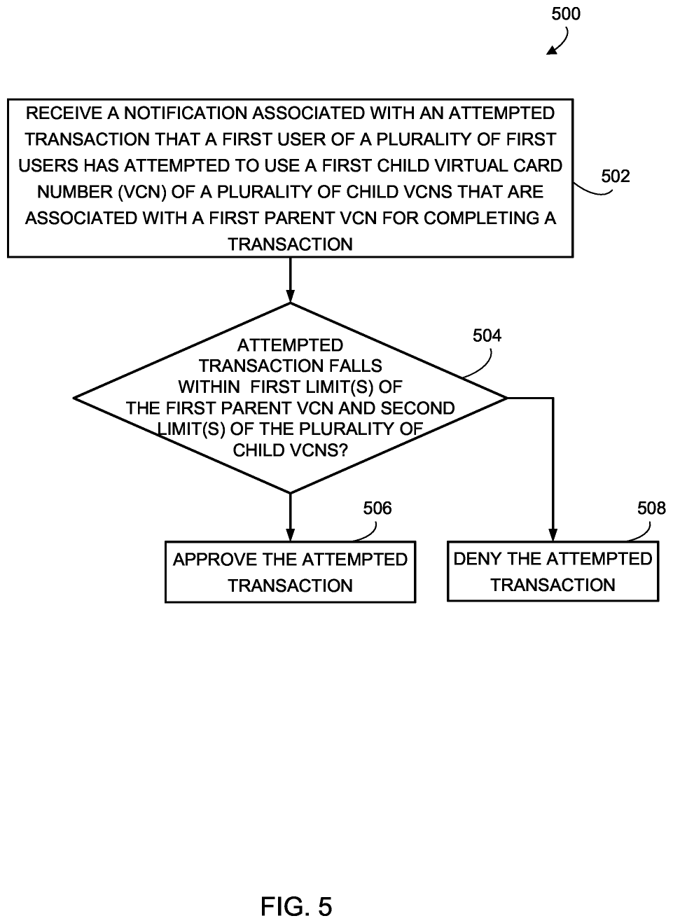

FIG. 5 shows a flowchart of a method 500 for processing VCNs. Method 500 may also be performed by virtual number generating system 114, user device 102, and/or third-party server 104. Method 500 is similar to method 300 of FIG. 3 except that method 500 does not include blocks similar to blocks 302, 304, 306, 308, and 310. The description of blocks 502, 504, 506, and 508 of method 500 are the same as or similar to the respective descriptions of blocks 312, 314, 316, and 318 of method 300, and as such, are not repeated herein for brevity.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices that may include mobile computing devices. Those skilled in the art will recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Cases

The following example use cases describe examples of a typical user flow pattern. They are intended solely for explanatory purposes and not in limitation.

In one example, a boss within a company may decide she would like to buy lunch for ten of her employees across company sites. The boss would like to pay for each of her employees' meals, but would like each employee to be able to select from where he or she would like to order lunch. The boss would also like to ensure each of the employees has up to $25 to spend on his or her lunch, and that each employee can select which day (Monday through Friday) of a designated week that he or she would like to buy lunch. The boss, using her laptop computer (e.g., user device 102), may first select one of the boss's own credit card accounts that she would like to use as financial backing for providing lunch for her ten employees. Once the boss selects the account, she can then generate (e.g., via virtual number generating system 114) a first parent VCN that is linked to her selected credit card account. The first parent VCN has an account number, expiration date, and CVV that are each different from those of her credit card account. The boss may then generate (e.g., via virtual number generating system 114) ten child VCNs, each of which has a card number and CVV that is different from those of the first parent VCN and those of the boss's selected credit card account. The boss may then place one or more limits on each of the ten child VCNs. That is, the boss may place a spend limit wherein each child VCN may only be used on a transaction up to $25. The boss may also place a time limit wherein each child VCN may only be used on a weekday (i.e., Monday through Friday) of a particular work week. The boss may also place a use limit wherein each child VCN may only be used for purchasing food products. Finally, the boss may choose to select an expiration date by which each of the child VCNs will no longer work. The boss may also enter preferences to receive a notification each time an employee's attempted transaction is either approved or denied, along with transaction information associated with the approved or denied transaction. The boss may opt for the notifications and transaction information to be displayed on a GUI of the boss's laptop in order of date and time, starting with the most recent transaction. Once the boss sets up the ten child VCNs, she may then send each child VCN to one of her ten employees via their respective email addresses. Once a first employee attempts to use his or her respective child VCN to complete a transaction (e.g., via third-party server 104), the system will determine whether to approve or deny the attempted transaction by comparing the attempted transaction data to the boss's previously entered spend, time, and use limits. If the attempted transaction data satisfies the limits, the system may approve the transaction. However, if the attempted transaction data does not meet one or more of the limits (e.g., the first employee attempts to purchase a meal for more than $25), the system may deny the attempted transaction. The system may repeat this process for each of the other nine child VCNs. The boss may receive a notification each time an attempted transaction is approved or denied, along with transaction information associated with each transaction, e.g., date, time, transaction amount, and merchant name. The boss may see the notifications and transaction information displayed in time and date order, as the boss previously entered. At any point throughout this process, if the boss has any trouble with a particular child VCN or employee, the boss may cancel one or more of the child VCNs without impacting the remaining child VCNs.

In another example, a parent may want to provide each of his three children with an allowance to be used for clothes shopping in preparation for a family vacation. The parent would like to ensure, however, that between the three children, they do not spend more than $300 total. The parent, using his mobile device (e.g., user device 102), may first select one of his personal credit card accounts that he would like to use as financial backing for providing the shopping allowance to his children. Once the parent selects the account, he can then generate (e.g., via virtual number generating system 114) a first parent VCN that is linked to his selected credit card account. The first parent VCN has an account number, expiration date, and CVV that are each different from those of his credit card account. The parent may then place one or more limits on the first parent VCN, for example, a total spending limit of $300 across all associated child VCNs. The parent may then generate (e.g., via virtual number generating system 114) three child VCNs, each of which has a card number and CVV that is different from those of the first parent VCN and those of the parent's selected credit card account. The parent may then place one or more limits on each of the three child VCNs. That is, the parent may place a use limit wherein each child VCN may only be used for purchasing clothing products. The parent may also choose to select an expiration date by which each of the child VCNs will no longer work. The parent may also enter preferences to receive a notification each time a child's attempted transaction is either approved or denied, along with transaction information associated with the approved or denied transaction. The parent may opt for the notifications and transaction information to be displayed on a GUI of the parent's mobile device in order of transaction amount, starting with the highest. Once the parent sets up the three child VCNs, he may then send each child VCN to one of his three children via their respective email addresses. Once a first child attempts to use his or her respective child VCN to complete a transaction (e.g., via third-party server 104), the system will determine whether to approve or deny the attempted transaction by comparing the attempted transaction data to the parent's previously entered total spend and use limits. If the attempted transaction data satisfies the limits, the system may approve the transaction. However, if the attempted transaction data does not meet one or more of the limits (e.g., the first child attempts to purchase something other than clothing, or the first child's transaction results in the total spending limit exceeding $300), the system may deny the attempted transaction. The system may repeat this process for each of the other two child VCNs. The parent may receive a notification each time an attempted transaction is approved or denied, along with transaction information associated with each transaction, e.g., merchant name and the total amount spent thus far across all three child VCNs. The parent may see the notifications and transaction information displayed in transaction amount order, as the parent previously entered. At any point throughout this process, if the total spending limit of $300 across all three child VCNs is achieved, the system may automatically cancel or turn off all three child VCNs.

1. A system for tiered virtual card number processing, comprising:
one or more processors; and
a memory in communication with the one or more processors and storing instructions that, when executed by the one or more processors, are configured to cause the system to:
receive, from an account holder via a first graphical user interface (GUI) of a user device, a selection of a first account associated with a first card number;
receive, from the account holder via the first GUI, a request to generate a first parent virtual card number (VCN) associated with the first account, wherein the first parent VCN comprises a pseudo-random number and is different from the first card number;
receive, from the account holder via the first GUI, a request to generate a plurality of child VCNs associated with the first parent VCN, wherein each child VCN is different from the first parent VCN and the first card number;
receive, from the account holder via the first GUI, one or more first limits for the first parent VCN and one or more second limits for the plurality of child VCNs,
wherein at least one of the one or more first limits comprises a total spending limit across the plurality of child VCNs;
generate the first parent VCN based on the one or more first limits;
generate the plurality of child VCNs that are each different from each other and are subject to the one or more first limits of the first parent VCN, and wherein each of the plurality of child VCNs is associated with the one or more second limits;
transmit the plurality of child VCNs to a plurality of first users; and
iteratively, until the total spending limit is reached:
receive a notification associated with an attempted transaction that a first user of the plurality of first users has attempted to use a first child VCN of the plurality of child VCNs for completing a transaction, wherein the notification comprises attempted transaction data;
determine whether the attempted transaction results in the total spending limit being reached;
responsive to determining that the attempted transaction does not result in the total spending limit being reached:
approve the attempted transaction; and
cause a second GUI of the user device to dynamically display the attempted transaction data and an indication of the total spending limit not being reached; and
responsive to determining that a first attempted transaction results in the total spending limit being reached:
generate a prompt requesting the account holder indicate whether to cancel each child VCN of the plurality of child VCNs;
cause the second GUI of the user device to display the prompt;
receive a response from the account holder via the second GUI, the response comprising an indication to cancel each child VCN of the plurality of child VCNs;
responsive to receiving the response, cancel each child VCN of the plurality of child VCNs; and
cause the second GUI of the user device to dynamically update based on the total spending limit being reached.

2. (canceled)

3. The system of claim 1, wherein the one or more second limits comprise a spend limit, a use limit, a time limit, a location limit, or combinations thereof.

4. The system of claim 1, wherein the instructions are further configured to cause the system to transmit the plurality of child VCNs to the plurality of first users by linking each of the plurality of child VCNs to a respective email address associated with each of the plurality of first users.

5. The system of claim 1, wherein the instructions are further configured to cause the system to cancel the plurality of child VCNs in response to the attempted transaction data falling outside of the one or more first limits.

6. The system of claim 1, wherein the instructions are further configured to cause the system to only cancel the first child VCN in response to the attempted transaction data falling outside of the one or more second limits associated with the first child VCN but not falling outside of the one or more first limits.

7. The system of claim 1, wherein the first parent VCN and each of the plurality of child VCNs is a token.

8. A system for virtual card number generation, comprising:
one or more processors; and
a memory in communication with the one or more processors and storing instructions that, when executed by the one or more processors, are configured to cause the system to:
receive, from an account holder via a first graphical user interface (GUI) of a user device, a selection of a first account associated with a first card number to generate a first parent VCN and a plurality of child VCNs;
receive one or more first limits for the first parent VCN and one or more second limits for the plurality of child VCNs;
generate the first parent VCN based on the one or more first limits, wherein the first parent VCN is associated with the first account, comprises a pseudo-random number, and is different from the first card number;
generate the plurality of child VCNs based on the one or more second limits, wherein the plurality of child VCNs is associated with the first parent VCN, and wherein each child VCN is different from the first parent VCN, the first card number, and each other;
transmit the plurality of child VCNs to a plurality of first users; and
iteratively, until a predefined limit is exceeded:
receive one or more notifications that one or more first users of the plurality of first users has attempted to use one or more first child VCNs of the plurality of child VCNs for initiating one or more transactions;
determine whether the one or more transactions fall within the one or more first limits and the one or more second limits;
responsive to determining that the one or more transactions fall within the one or more first limits and the one or more second limits:
approve the one or more transactions; and
cause a second GUI of the user device to dynamically display the one or more transactions and an indication that the one or more transactions fall within the one or more first limits and the one or more second limits; and
responsive to determining that a first transaction falls outside of the one or more first limits or the one or more second limits:
generate a prompt requesting the account holder indicate whether to cancel each child VCN of the plurality of child VCNs;
cause the second GUI of the user device to display the prompt;
receive a response from the account holder via the second GUI, the response comprising an indication to cancel each child VCN of the plurality of child VCNs;
responsive to receiving the response, cancel each child VCN of the plurality of VCNs; and
cause the second GUI to dynamically update based on the first transaction falling outside of the one or more first limits or the one or more second limits.

9. The system of claim 8, wherein the one or more first limits comprise a total spending limit across the plurality of child VCNs.

10. (canceled)

11. The system of claim 8, wherein the instructions are further configured to cause the system to only cancel a first child VCN of the plurality of child VCNs in response to an attempted transaction utilizing the first child VCN falling outside of the one or more second limits associated with the first child VCN but not falling outside of the one or more first limits.

12. The system of claim 8, wherein the one or more second limits comprise a spend limit, a use limit, a time limit, a location limit, or combinations thereof.

13. The system of claim 8, wherein the instructions are further configured to cause the system to receive respective email addresses of the plurality of first users, wherein the plurality of child VCNs are transmitted to the respective email addresses of the plurality of first users.

14. The system of claim 8, wherein the first parent VCN and each of the plurality of child VCNs is a token.

15. A system for shared event virtual card number processing, comprising:
one or more processors; and
a memory in communication with the one or more processors and storing instructions that, when executed by the one or more processors, are configured to cause the system to:
iteratively, until a limit is exceeded:
receive a notification associated with an attempted transaction that a first user of a plurality of first users has attempted to use a first child virtual card number (VCN) of a plurality of child VCNs that are associated with a first parent VCN for completing a transaction,
wherein the notification comprises attempted transaction data;
wherein each of the plurality of child VCNs are subject to one or more first limits of the first parent VCN, are different from the first parent VCN, and are associated with one or more second limits; and
wherein the first parent VCN is associated with a first account number and comprises a pseudo-random number that is different from the first account number;
determine whether the attempted transaction data falls within the one or more first limits and the one or more second limits;
responsive to determining that the attempted transaction data falls within the one or more first limits and the one or more second limits:
approve the attempted transaction; and
cause a graphical user interface (GUI) of a user device to dynamically display the attempted transaction data and an indication that the attempted transaction falls within the one or more first limits and the one or more second limits; and
responsive to determining that the attempted transaction data falls outside of the one or more first limits or the one or more second limits:
deny the attempted transaction;
generate a prompt requesting a user indicate whether to cancel each child VCN of the plurality of child VCNs;
receive a response from the user via the GUI of the user device, the response comprising an indication to cancel each child VCN of the plurality of child VCNs;
responsive to receiving the response, cancel each child VCN of the plurality of child VCNs; and
cause the GUI of the user device to dynamically update based on the denying of the attempted transaction, the user device being associated with an account holder of the first account number.

16. The system of claim 15, wherein the first parent VCN is associated with a first account, and wherein the first account is associated with a first card number that is different from the first parent VCN.

17. The system of claim 15, wherein the one or more first limits comprise a total spending limit across the plurality of child VCNs.

18. The system of claim 15, wherein the one or more second limits comprise a spend limit, a use limit, a time limit, a location limit, or combinations thereof.

19. The system of claim 15, wherein the first parent VCN and each of the plurality of child VCNs is a token.

20. (canceled)

21. The system of claim 1, wherein the instructions are further configured to cause the system to:
receive, from the account holder via a third GUI, one or more display preferences, and
wherein causing the second GUI of the user device to dynamically update is further based on the one or more display preferences.

22. The system of claim 21, wherein the one or more display preferences comprise displaying, via the second GUI, transaction information associated with the attempted transaction, and placing an approval indication or a denial indication proximate the transaction information based on whether the attempted transaction was approved or denied.
